(19) United States
(12) Patent Application Publication
(10) Pub. No.: US 2020/0393727 A1
(43) Pub. Date: Dec. 17, 2020

(54) LIQUID CRYSTAL DISPLAY DEVICE AND METHOD OF MANUFACTURING THEREOF

(71) Applicant: Mitsubishi Electric Corporation, Tokyo (JP)

(72) Inventor: Kazushi KIYOTA, Kumamoto (JP)

(73) Assignee: Mitsubishi Electric Corporation, Tokyo (JP)

(21) Appl. No.: 16/881,604

(22) Filed: May 22, 2020

(30) Foreign Application Priority Data
Jun. 12, 2019 (JP) 2019-109645

(51) Int. Cl. G02F 1/1337; G02F 1/1368; G02F 1/1343; G02F 1/1335; G02F 1/13363

(52) U.S. Cl. CPC G02F 1/133784; G02F 1/1368; G02F 1/134363; G02F 1/133788; G02F 2413/01; G02F 1/13363; G02F 2413/12; G02F 2413/13; G02F 2413/14; G02F 1/133528

(57) ABSTRACT

A liquid crystal display device includes an array substrate on which a plurality of thin film transistors are arranged, a counter substrate arranged to face the array substrate, a liquid crystal layer interposed between the array substrate and the counter substrate, and a liquid crystal panel of a transverse field system in which liquid crystal is driven by an electric field generated in a direction parallel to the array substrate and the counter substrate. The liquid crystal panel includes a first alignment film provided on the array substrate side, and a second alignment film provided on the counter substrate side. The first and second alignment films have photo-alignment properties. At least one of the first and second alignment films has a surface on which weak rubbing treatment is performed, of which pushing amount of the rubbing roller in the rubbing treatment is in the range of 0.01 to 0.30 mm.

### BACKGROUND OF THE INVENTION

### Field of the Invention

The present invention relates to a liquid crystal display device, and more particularly, to a liquid crystal display device having a transverse field system liquid crystal panel.

### Description of the Background Art

In recent years, an alignment film for photo-alignment has been more adopted in a transverse field crystal liquid display device due to its advantages including low viewing angle dependency, high display quality, and no alignment anomalies generating at the steps in an alignment film for rubbing.

Meanwhile, the alignment film for photo-alignment adopts the non-contact type alignment treatment, therefore, good uniformity of display is ensured, however, foreign substance induced faint bright spots and faint bright spots induced from alignment film cissing portions, which are, even though relatively minute in size, are observed as faint bright spot defects. Therefore, the alignment film for photo-alignment is disadvantageous in having an inclination to generate the faint bright spot defects.

On the other hand, for the alignment film for rubbing, the alignment film is rubbed directly with a cloth, so that a certain degree of alignment is provided even without an alignment film on the substrate surface; therefore, foreign substance induced faint bright spots and faint bright spots induced from alignment film cissing portions are not observed as faint bright spot defects as long as these faint bright spots are relatively small in size. That is, as compared with the alignment film for photo-alignment, a faint bright spot defect is less likely to occur.

Further, in a liquid crystal display device for in-vehicle use, a liquid crystal display device is desired, in which the optimal viewing angle direction is shifted slightly upward with respect to the display surface of the liquid crystal panel. In a transverse field system liquid crystal display device, in order to adjust such an optimum viewing angle direction in a specific direction, it is effective that the liquid crystal molecules are aligned vertically with respect to the display screen, and to control a pretilt angle, which is an initial alignment of the liquid crystal molecules, to a relatively low and appropriate range.

However, in order to obtain an alignment regulation force of a certain level or more in the alignment film for rubbing, rubbing treatment with certain strength is required to be implemented, and the pretilt angle becomes relatively high. Therefore, the control of the pretilt angle to the relatively low range described above is difficult. On the other hand, in the alignment film for photo-alignment, setting the pretilt angle to any degrees other than 0° is difficult. That is, obtaining the above-mentioned shifted slightly upward optimal viewing angle characteristics has been difficult when using either the alignment film for rubbing or the alignment film for photo-alignment.

In addition, instead of simply replacing the disadvantage that the alignment anomalies easily occur at the steps in the alignment film for rubbing with the alignment film for photo-alignment, Japanese Patent Application Laid-Open No. 11-305256 describes a method in which rubbing treatment and photo-alignment treatment are used in combination to suppress the alignment anomalies at steps. In this method, the rubbing treatment and the photo-alignment treatment are used in combination; therefore, the characteristics, obtained with the alignment film for photo-alignment, of the low viewing angle dependency, high display quality, further, characteristics of no alignment anomalies at the steps, and that a faint bright spot defect due to being subjected to the rubbing treatment is less likely to occur, may be obtained.

### SUMMARY

Here, in the configuration of Japanese Patent Application Laid-Open No. 11-305256, the photo-alignment treatment is combined as an auxiliary role to compensate for the alignment anomalies at the steps due to the rubbing treatment, and a relatively strong rubbing treatment is performed because providing the alignment regulation force to the alignment film is basically assumed to be performed by the rubbing treatment. Therefore, the pretilt angle to be formed is a relatively high pretilt equivalent to that obtained by the rubbing treatment. In other words, in the above configuration, controlling the pretilt angle to a relatively low range to obtain the optimal viewing angle characteristics shifted slightly upward is as difficult as in the general cases with the alignment film for rubbing and the alignment film for photo-alignment.

Provided is a liquid crystal display device capable of adjusting an optimum viewing angle direction in a specific direction and preventing occurrence of a faint bright spot defect.

According to the liquid crystal display device includes an array substrate on which a plurality of thin film transistors are arranged, a counter substrate arranged to face the array substrate, a liquid crystal layer interposed between the array substrate and the counter substrate, and a liquid crystal panel of a transverse field system in which liquid crystal is driven by an electric field generated in a direction parallel to the array substrate and the counter substrate. The liquid crystal panel includes a first alignment film provided on the array substrate side, and a second alignment film provided on the counter substrate side. The first and second alignment films have photo-alignment properties. At least one of the first and second alignment films has a surface on which weak rubbing treatment is performed, of which pushing amount of the rubbing roller in the rubbing treatment is in the range of 0.01 to 0.30 mm.

According to the above-described liquid crystal display device, an optimus viewing angle direction in a specific direction can be set and occurrence of a faint bright spot defect can be prevented.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a planar configuration of a liquid crystal panel of a liquid crystal display device according to Embodiment 1 of the present invention;

FIG. 2 is a diagram illustrating a cross section configuration of the liquid crystal panel of the liquid crystal display device according to Embodiment 1 of the present invention;

FIG. 3 is a partial sectional view illustrating a configuration of an alignment film of the liquid crystal panel of the liquid crystal display device according to Embodiment 1 of the present invention;

FIG. 4 is a diagram illustrating a state of pretilt of liquid crystal molecules in the liquid crystal panel of the liquid crystal display device according to Embodiment 1 of the present invention;

FIG. 5 is a diagram illustrating a state of pretilt of the liquid crystal molecules when an alignment film obtained by performing only photo-alignment treatment on a general alignment film for photo-alignment is used;

FIG. 6 is a diagram illustrating a state of pretilt of the liquid crystal molecules when an alignment film obtained by performing only anti-parallel rubbing treatment on a general alignment film for rubbing is used;

FIG. 7 is a diagram illustrating a state of pretilt of the liquid crystal molecules when the anti-parallel rubbing treatment is not performed in the liquid crystal panel of the liquid crystal display device according to Embodiment 1 of the present invention;

FIG. 8 is a diagram illustrating a configuration in which a viewing angle direction is adjustable in the liquid crystal panel of the liquid crystal display device according to Embodiment 1 of the present invention;

FIG. 9 is a diagram illustrating an optical design provided on the liquid crystal panel of the liquid crystal display device according to Embodiment 1 of the present invention;

FIG. 10 is a cross-sectional view illustrating a state in which an alignment film cissing portion appears in the liquid crystal panel of the liquid crystal display device according to Embodiment 1 of the present invention;

FIG. 11 is a partial sectional view illustrating the alignment film cissing portion appeared in the liquid crystal panel of the liquid crystal display device according to Embodiment 1 of the present invention;

FIG. 12 is a diagram illustrating an effect of suppressing the occurrence of faint bright spot defects in the liquid crystal panel of the liquid crystal display device according to Embodiment 1 of the present invention;

FIG. 13 is a diagram illustrating an effect of suppressing the occurrence of the faint bright spot defects in the liquid crystal panel of the liquid crystal display device according to Embodiment 1 of the present invention;

FIG. 14 is a diagram illustrating an effect of suppressing the occurrence of the faint bright spot defects in the liquid crystal panel of the liquid crystal display device according to Embodiment 1 of the present invention;

FIG. 15 is a diagram illustrating a configuration of the liquid crystal panel of the liquid crystal display device according to Modification 1 of Embodiment 1 of the present invention;

FIG. 16 is a diagram illustrating an optical design provided on the liquid crystal panel of the liquid crystal display device according to Modification 1 of Embodiment 1 of the present invention;

FIG. 17 is a diagram illustrating a configuration of the liquid crystal panel of the liquid crystal display device according to Modification 2 of Embodiment 1 of the present invention; and

FIG. 18 is a diagram illustrating an optical design provided on the liquid crystal panel of the liquid crystal display device according to Modification 2 of Embodiment 1 of the present invention.

### DESCRIPTION OF THE PREFERRED EMBODIMENTS

### Embodiment 1

In the following, a transverse field system liquid crystal panel driven with a thin film transistor (TFT) as a switching element, and in particular, a liquid crystal panel of fringe field switching (FFS) system will be described, as an example.

<Overall Configuration of Liquid Crystal Panel>

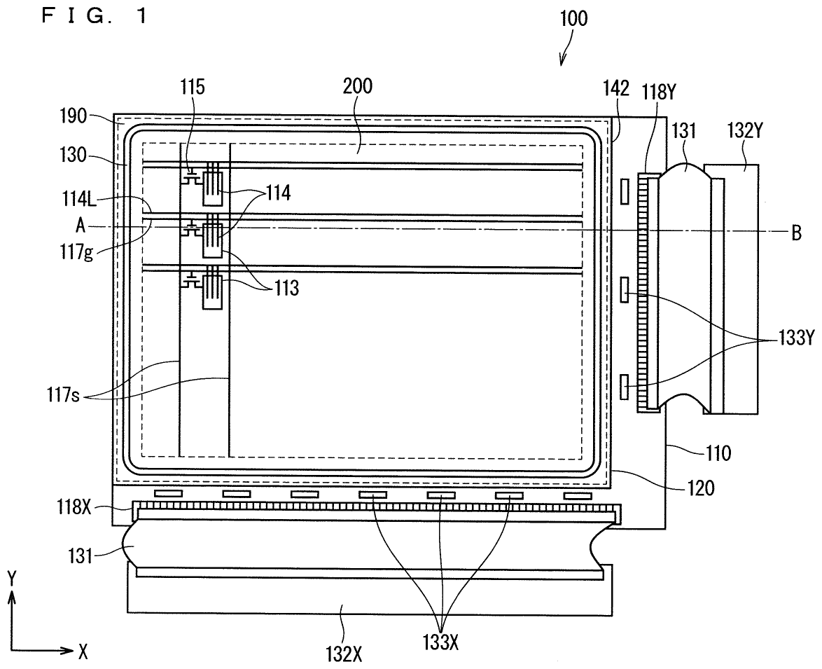

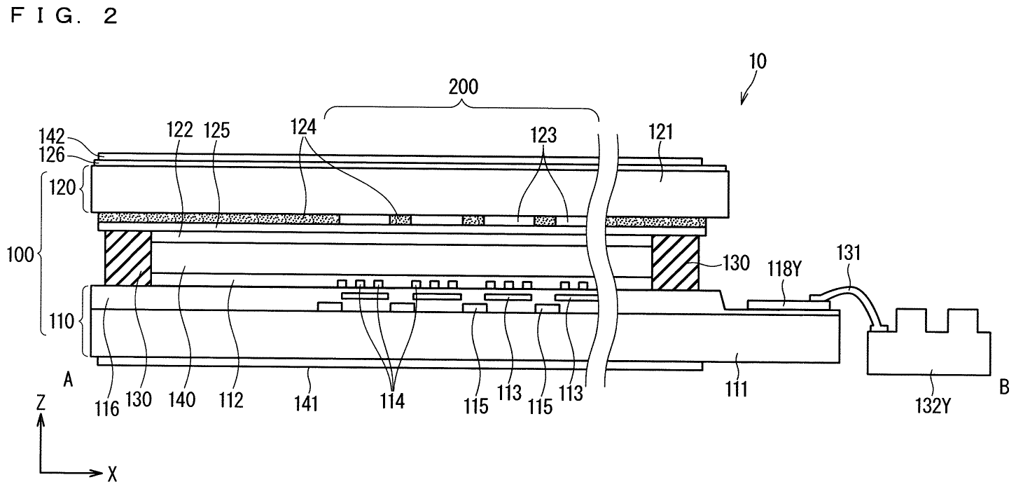

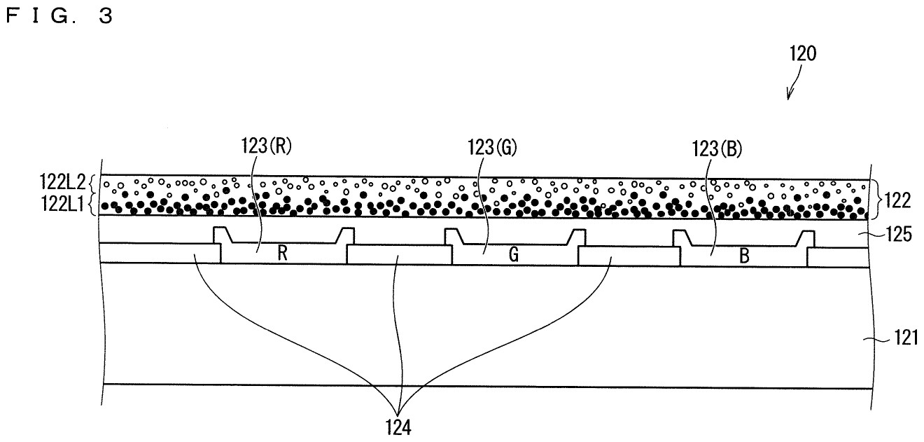

An overall configuration of a liquid crystal panel constituting a liquid crystal display device according to the present invention will be described with reference to FIGS. 1 and 2. FIG. 1 is a plan view illustrating a planar configuration of a liquid crystal panel 100 of Embodiment 1, and FIG. 2 is a cross-sectional view taken along line A-B in FIG. 1. FIG. 3 illustrates a partial cross section for explaining a configuration of an alignment film. Note that, the drawings are schematic and do not reflect the exact sizes of the components illustrated therein. In addition, the repetitive parts of the display pixels are omitted and the film configuration is partially simplified. In the drawings, the same components as those described in the previous drawings are denoted by the same reference numerals, and the description thereof will be omitted. This applies to the other drawings.

The liquid crystal panel 100 illustrated in FIGS. 1 and 2 includes a TFT array substrate (hereinafter, referred to as an array substrate) 110 in which TFTs are arranged in a matrix to form a TFT array, a color filter substrate (hereinafter, referred to as a counter substrate) 120 having a display area 200 serving as a display surface for displaying an image, which is arranged to face the array substrate 110, and a sealing material 130 arranged to surround a region corresponding to the display region 200, providing a gap between the counter substrate 120 and the array substrate 110, and sealing the gap. Also, a liquid crystal layer 140 is sealed in a region surrounded by the sealing material 130 and corresponding to the display region 200 between the array substrate 110 and the counter substrate 120.

The sealing material 130 is arranged in a frame region 190 provided outside the area corresponding to the display area 200. The outer shapes of the array substrate 110 and the counter substrate 120 are both rectangular, and the outer shape of the array substrate 110 is larger than the outer shape of the counter substrate 120 and protrudes in a plan view. In other words, in the drawing, in the side on the lower side and the side on the right side of the edge portion of the array substrate 110, where the signal terminals 118X and 118Y described later are provided, the array substrate 110 has a protruding portion which is outer edge thereof protruding from the outer edge of the counter substrate 120, and is arranged with the counter substrate 120 being superposed thereon.

Note that the frame region 190 is a frame-shaped region that is located outside the display region 200 and surrounds the display region 200 on the array substrate 110, the counter substrate 120, or a region defined by both substrates of the liquid crystal panel 100, that is, the frame region 190 means all areas other than the display area 200 surrounded by a broken line in FIG. 1.

Further, between the array substrate 110 and the counter substrate 120, a plurality of columnar spacers (not illustrated) for keeping the gap at a fixed distance are arranged in the display area 200. In other words, the column spacers maintain the distance between the substrates within a certain range. In Embodiment 1, a dual spacer structure in which two different types of columnar spacers are arranged in a mixed manner is used. In this dual spacer structure, for a columnar spacer of a first form is, for example, a spacer having a relatively high height or a spacer having a relatively long length in a direction perpendicular to each substrate surface is used: thereby, the spacer functions as a spacer (referred to as a main spacer) that comes into contact with each substrate surface in normal time and holds between the substrates. Meanwhile, for a columnar spacer of a second form, a spacer having a relatively low height or a spacer having a relatively short length in the direction perpendicular to each substrate surface is used; thereby, the spacer functions as a spacer (referred to as a sub spacer) that does not come into contact with one substrate in normal time but holds between the substrates by coming into contact with the one substrate only when the distance between the substrates is reduced.

The array substrate 110 and the opposing substrate 120, which are a pair of substrates arranged to face each other, are arranged on a glass substrate 111 and a glass substrate 121, which are transparent insulating substrates, respectively.

That is, the counter substrate 120 includes an alignment film 122 (second alignment film) for aligning liquid crystal and color filters 123 provided below the alignment film 122, here, color material layers corresponding to (R), green (G) and blue (B) that are three primary colors are arranged, in, for example, a region corresponding to at least the display region 200 on one main surface of the glass substrate 121 set to a thickness of about 0.3 mm. Further, light shielding layers 124 for shielding light between the color filters 123 are provided. The light shielding layers 124 are also provided so as to shield an area corresponding to the frame region 190 provided outside the display area 200 from light. The light shielding layer 124 may be referred to as a black matrix (BM) 124 in some cases. Further, an overcoat layer (OC layer) 125, which is a transparent resin film for covering the surfaces of the color filters 123 and BMs 124 and planarizing the surface steps of the color filters 123 and BMs 124, is provided below the alignment film 122.

In Embodiment 1, for the alignment film 122 formed on the counter substrate 120, a photo-alignment film having an alignment regulation force by performing photo-alignment treatment on the photo-alignment film material is used, in particular, a phase-separating photo-alignment film having different compositions, properties, and the like on the upper layer side and the lower layer side is used. The alignment film 122 has one of particularly characteristic configurations; therefore, the configuration, the manufacturing method, and the like thereof will be described later in detail.

In addition, the columnar spacers described above are provided between the array substrate 110 and the counter substrate 120, and both the main spacer and the sub spacer are provided in a fixed manner on the surface of the OC layer 125 on the counter substrate 120 side.

Further, on the other main surface of the glass substrate 121 of the counter substrate 120, that is, on the main surface opposite to the main surface on which the color filters 123, BMs 124 and the like are provided, a transparent conductive layer 126 for preventing static electricity that is connected to ground is provided. The transparent conductive layer 126 for preventing static electricity is provided, in a manner, for example, that the transparent conductive layer 126 covers at least the display area 200 of the glass substrate 121 with a transparent conductive film such as an indium tin oxide (ITO) film, and is effective for preventing electro static charge due to static electricity and display failure due to an external electric field in a liquid crystal panel of an in-plane-switching system.

Next, the configuration of the array substrate 110 will be described. The array substrate 110 includes an alignment film 112 (first alignment film) for aligning liquid crystal, a pair of pixel electrodes 113 and counter electrodes 114, which are provided below the alignment film 112 and generate an electric field in a direction parallel to the main surface of the array substrate 110 or the counter substrate 120 to drive the liquid crystal, TFTs 115 for applying a voltage to the pixel electrodes 113, and an insulating film 116 covering the TFTs 115 in. for example, a region corresponding to at least the display region 200 on one main surface of the glass substrate 111 set to a thickness of about 0.3 mm. Further, as illustrated in FIG. 1, a plurality of scanning signal lines (hereinafter, gate wiring) 117g and video signal lines (hereinafter, source wiring) 117s for supplying signals to the TFTs 115 are provided. Note that, for the alignment film 112, similarly to the alignment film 122 provided on the counter substrate 120, a photo-alignment film having an alignment regulation force by performing the photo-alignment treatment on a photo-alignment film material is used.

Further, the TFT 115 includes a semiconductor layer serving as an active layer of the transistor, and a gate electrode, a source electrode, a drain electrode, and the like provided on the semiconductor layer in an overlapping manner. Note that, illustration of each electrode is omitted. Note that. the gate electrode may be provided as part of the gate wiring 117g (FIG. 1).

Further, as illustrated in FIG. 1, each of a plurality of TFTs 115 arranged in a matrix is connected to a source wiring 117s via a source electrode, and electrically connected to a pixel electrode 113 via a drain electrode. In FIG. 1, a connection is made between the TFT 115 and the pixel electrode 113, and only the connection relationship is conceptually illustrated. Further, the gate wiring 117g, the source wiring 117s, and the gate electrode, the source electrode, and the drain electrode constituting the TFT 115 are formed of a metal film serving as a light shielding layer.

Further, in Embodiment 1, the pixel electrode 113 and the counter electrode 114 which make up a pair of electrodes for applying a voltage for driving the liquid crystal are schematically illustrated in the sectional view. The pixel electrode 113, which is one of the electrodes, is formed of a plate-shaped transparent conductive film pattern, and the counter electrode 114, which is the other electrode, is formed of a transparent conductive film pattern of a slit electrode having a plurality of slit-shaped openings provided in parallel in a region overlapping with the pixel electrode 113.

Further, as schematically illustrated in FIG. 1 which is a plan view, the extending direction of the slit-shaped opening provided in the counter electrode 114 is in the vertical direction (Y direction) in the drawing, that is, the up and down direction in the display area 200.

In addition, the counter electrode 114 is disposed over the pixel electrode 113 via the insulating film 116, at least in a region where the slit electrode is formed. Further, the transparent conductive film pattern forming the counter electrode 114 may have a configuration in which an opening is provided in a region overlapping with the TFT 115.

Further, the configuration and arrangement of the pixel electrode 113 and the counter electrode 114 are not limited to the above, a configuration in which the shape and arrangement of each of the pixel electrode 113 and the counter electrode 114 are reversed, the pixel electrode 113 is disposed in a layer above the counter electrode 114 as a pattern in which comb-tooth shaped or a plurality of slit-shaped openings are formed in parallel, the counter electrode 114 is formed in a plate-shape and disposed below the pixel electrode 113, and the TFT 115 is electrically connected to the pixel electrode 113 having a comb-tooth shaped or a plurality of slit-shaped openings to apply a voltage.

For both the pixel electrode 113 and the counter electrode 114, a comb-tooth shaped comb electrode that has been generally used as an electrode of an in-plane switching system may be used. In the case of a comb electrode, the extension direction of the comb electrode is the vertical direction (Y direction) in the drawing, that is, the up and down direction in the display region 200, similarly to the extension direction of the slit electrode.

Although illustration and description of specific planar pattern shapes of the pixel electrode 113 and the counter electrode 114 are omitted, a planar pattern shape of a pixel electrode and a counter electrode used in a liquid crystal panel using a known FFS system may be adopted.

Also, for the insulating film 116 on the array substrate 110, in the drawing, each insulating film that mutually insulates the semiconductor layer, the gate electrode, the source electrode, and the drain electrode that constitute the TFT 115, and the insulating film that covers the TFT 115, or the insulating film formed between the pixel electrode 113 and the counter electrode 114 and the other insulating films are simplified and illustrated as an integrated insulating film. However, practically, a single-layer transparent insulating film or a laminated film of a plurality of transparent insulating films is formed between each of the electrodes or the like.

Next, the configuration provided on the frame region 190 of the array substrate 110 will be described. As illustrated in FIG. 1, in a protruding portion of the frame region 190 on the array substrate 110 that protrudes from the outer edge of the counter substrate 120, the main surface on the side where the counter substrate 120 is disposed is provided with signal terminals 118X and 118Y that receive signals supplied to the TFT 115 from the outside. Note that, the cross-sectional view of FIG. 2 illustrates a state where the signal terminal 118Y is provided only at one end of the array substrate 110, but the signal terminal 118X is provided at a protruding portion provided on an adjacent side.

In FIG. 1, the signal terminal 118Y provided on a side parallel to the Y direction supplies a scanning signal to the gate wiring 117g, and the signal terminal 118X provided on a side parallel to the X direction supplies a video signal to the source wiring 117s. The signal terminals 118X and 118Y have a structure in which a plurality of rectangular electrode pads electrically separated corresponding to a plurality of signals are arranged along the end portion of the substrate in detail.

And, to the respective electrode pads for the signal terminals 118X and 118Y, a control substrate 132X and a control substrate 132Y are connected in which a control integrated circuit (IC) chip that generates a control signal for controlling a drive IC via a flexible flat cable (FFC) 131 serving as a connection wiring is provided.

The control signals from the control substrates132X and 132Y are input to the driving IC chips 133X and 133Y attached to the protrusions via the signal terminals 118X and 118Y, respectively, and output signals output from the driving IC chips 133X and 133Y are supplied to the TFT 115 in the display area 200 via a plurality of signal extraction wirings (not illustrated) drawn from the display area 200.

Further, as illustrated in FIG. 2, a polarizing plate 141 (first polarizing plate) is provided on an outer surface of the array substrate 110 opposite to the liquid crystal layer 140. Also a polarizing plate 142 (second polarizing plate) is provided on the transparent conductive layer 126 provided on the outer surface of the counter substrate 120 opposite to the liquid crystal layer 140. The polarizing plates 141 and 142 are arranged so as to cover at least the display area 200 of the array substrate 110 and the counter substrate 120, respectively, and are attached and fixed via an adhesive layer (not illustrated). Although the polarizing plates 141 and 142 are illustrated as a single-layer structure, the polarizing plates 141 and 142 have a laminated structure in which a protective layer such as a triacetyl cellulose (TAC) layer, a polarizing layer (a polarizing film layer), and the like are bonded.

Further, the transparent conductive layer 126 formed on the main surface of the counter substrate 120 is grounded. Although a detailed description of the connection structure is omitted with reference to the drawings, for example, an earth pad is provided on the protruding portion of the array substrate 110, and the transparent conductive layer 126 and the earth pad can be connected via a conductive paste or a conductive tape. A general silver paste can be used as the conductive paste, and a conductive tape obtained by applying a conductive adhesive to a base material of a metal foil such as an Al (aluminum) foil or a Cu (copper) foil can be used as the conductive tape. A common commercially available conductive tape can be used.

Further, a backlight unit (not illustrated) serving as a light source is disposed facing the array substrate 110 on the opposite side of the display area 200 of the liquid crystal panel 100, and an optical sheet (not illustrated) for controlling the polarization state, directivity, and the like of the light is disposed between the liquid crystal panel 100 and the backlight unit.

Further, the liquid crystal panel 100 is housed in a housing (not illustrated) having an opening in a display area portion including the display area 200 of the counter substrate 120 together with the above-described members such as the backlight unit and the optical sheet, and constitutes the liquid crystal display device 10 (FIG. 2).

The liquid crystal display device 10 operates as follows. For example, when an electric signal is input from the control substrates 132X and 132Y, a driving voltage is applied to the pixel electrode 113 and the counter electrode 114, and the alignment of the liquid crystal molecules in the liquid crystal layer 140 changes according to the driving voltage. Then, light emitted from the backlight disposed on the back side of the liquid crystal panel 100 is transmitted or blocked to the observer side via the array substrate 110, the liquid crystal layer 140, and the counter substrate 120, so that video is displayed on the display area 200 of the liquid crystal panel 100.

<Configuration of Alignment Film>

Next, for the structure of the alignment film, the structure in the thickness direction of the alignment film 122 formed on the main surface of the counter substrate 120 will be described in detail with reference to FIG. 3. The alignment film 122 includes a first layer 122L1 formed on the counter substrate 120, and a second layer 122L2 formed on the first layer 122L1. That is, in its thickness direction, the alignment film 122 includes the first layer 122L1 disposed relatively lower layer side thereof and a second layer 122L2 disposed above the first layer 122L1. The first layer 122L1 disposed on the lower layer side is formed of an alignment material having high conductivity, and the second layer 122L2 disposed on the upper layer side is formed of an alignment material having photo-alignment properties.

Although a description of a specific method of manufacturing the alignment film 122 is omitted, a phase-separated alignment film formed by transferring and coating a mixed material of two different kinds of precursors and then heating and phase-separating the mixed material is used. An image expressing the configuration of the alignment film 122, which is the structural feature, is a state in which, an alignment agent (a first alignment agent) forming the first layer 122L1 located on the lower layer side and an alignment agent (a second orientation agent) constituting 122L2 forming the second layer located on the upper layer side are mixed and distributed to some extent at the boundary portion, and not clearly separated into two layers on the upper layer side and the lower layer side.

For the structure obtained by phase separation, the two layer structure which is a slightly different depending on the characteristics of the two kinds of materials to be mixed, how the material formed on the lower layer side and the underlayer conform each other, the detailed conditions of the formation process, and the like is obtained. Typically, as to the concentration distribution, on the lower layer side of the alignment film 122, the alignment agent formed of the first layer 122L1, that is, the concentration of the alignment agent mainly contained in the first layer 122L1 is high, and a concentration gradient is gradually reduced from the lower layer toward the upper layer. Meanwhile, on the upper layer side of the alignment film 122, the alignment agent formed of the second layer 122L2, that is, the concentration of the alignment agent mainly contained in the second layer 122L2 is high, and a concentration gradient is gradually reduced from the upper layer toward the lower layer.

In addition, weak rubbing treatment is performed on the surface of the alignment film 122 on the counter substrate 120, and after the rubbing treatment, further, photo-alignment treatment in which predetermined polarized light is irradiated, which is the treatment for aligning an alignment material having photo-alignment properties, is performed. By performing the photo-alignment treatment, a display with good uniformity can be obtained.

As a degree of the weak rubbing treatment, for example, it is desirable to adjust the pushing amount of the rubbing roller in the rubbing treatment to a range of 0.01 to 0.30 mm. By adjusting to this range, a pretilt angle of a minute angle of less than 1° can be given to the liquid crystal molecules.

Although not illustrated in the drawings, the alignment film 112 on the array substrate 110 is also a phase separation type alignment film similar to the alignment film 122, and the same weak rubbing treatment and photo-alignment treatment as the alignment film 122 are performed. Note that the rubbing treatment performed on the surface of the alignment film 122 on the counter substrate 120 and the rubbing treatment performed on the surface of the alignment film 112 on the array substrate 110 are common in that the weak rubbing treatment is performed. However, the anti-parallel alignment treatment is performed such that the alignment directions of the counter substrate 120 and the array substrate 110 are different from each other by 180 degrees.

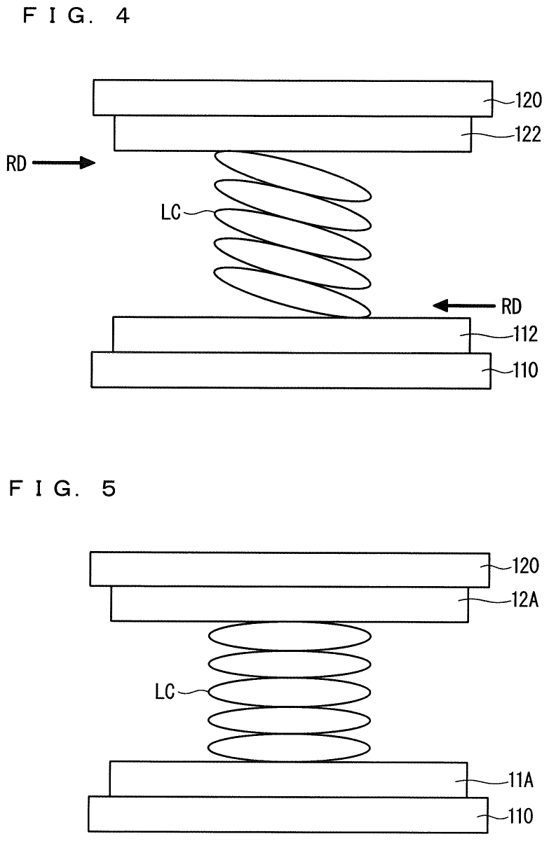

FIG. 4 schematically illustrates the result of using the above-described alignment film. FIG. 4 illustrates a pretilt state of liquid crystal molecules obtained by the alignment film 122 on the counter substrate 120 and the alignment film 112 on the array substrate 110, and this is the initial alignment. As illustrated, the liquid crystal molecules LC have a pretilt having a minute angle of degree of about less than 1°. The degree of the pretilt angle slightly varies depending on the strength of the weak rubbing treatment, specifically, by adjusting the pushing amount of the rubbing roller in the rubbing treatment. However, as described above, by selecting the pushing amount of the rubbing roller in the rubbing treatment in the range of 0.01 to 0.30 mm, the pretilt angle can be controlled in the range of 0.2° to 0.8°.

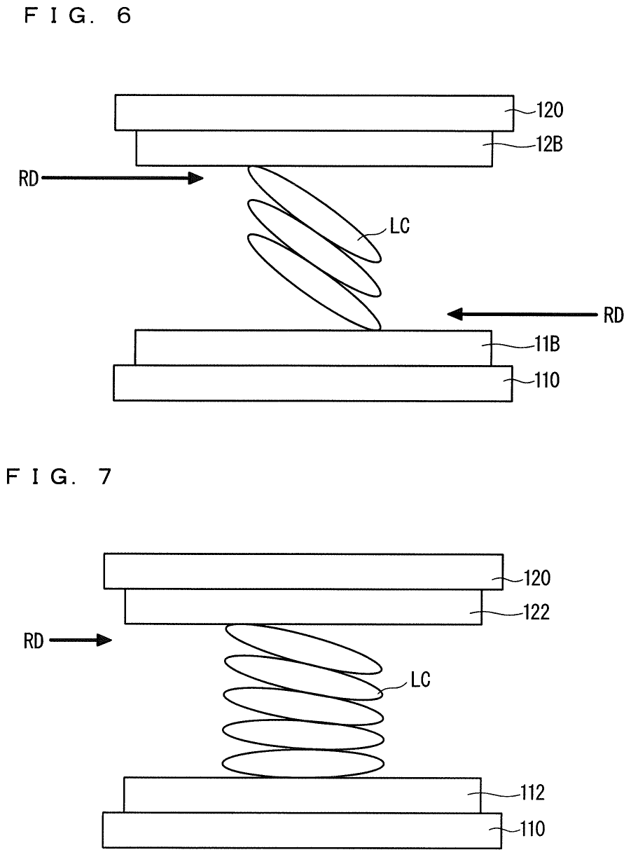

As a comparative example, FIG. 5 illustrates a pretilt state of liquid crystal molecules LC obtained by alignment films 12A and 11A obtained by performing only the photo-alignment treatment as alignment treatment using a general alignment film for photo-alignment, and FIG. 6 illustrates a pretilt state of the liquid crystal molecules LC obtained by the alignment films 12B and 11B obtained by performing only antiparallel rubbing treatment as alignment treatment using a general alignment film for rubbing. In the case of FIG. 5, as illustrated, providing a pretilt angle per se is difficult, and in the case of FIG. 6, as illustrated, a relatively high angle pretilt is formed and a certain level of alignment regulation force is obtained, which makes it difficult to control the pretilt angle to a minute value.

In the liquid crystal panel 100 of Embodiment 1, by providing the alignment films 112 and 122 having the above-described configuration, a minute pretilt angle of less than 1° can be formed between liquid crystal molecules and the alignment films 112 and 122 with good reproducibility.

In the description with reference to FIG. 4, although the weak rubbing treatment is performed on both the alignment film 122 on the counter substrate 120 and the alignment film 112 on the array substrate 110, the rubbing treatment performed on one of the substrates may be omitted. FIG. 7 illustrates the result in this case.

FIG. 7 illustrates a pretilt state of liquid crystal molecules LC in which the weak rubbing treatment is performed only on the alignment film 122 on the counter substrate 120, the weak rubbing treatment is omitted on the alignment film 112 on the array substrate 110, and only the photo-alignment treatment is performed. As illustrated in FIG. 7, no pretilt is formed near the array substrate 110, and a minute pretilt angle is formed near the counter substrate 120. Also in this case, a pretilt angle of a minute angle of less than 1° was able to be formed between the liquid crystal molecules and the alignment films 112 and 122 with good reproducibility.

As described above, in the liquid crystal panel 100 of Embodiment 1, the configuration is adopted in which a minute pretilt angle can be formed using the photo alignment film, and further, by utilizing the minute pretilt angle, an optimal direction of the viewing angle with respect to the display area 200, that is, a direction in which the contrast is maximized can be adjusted.

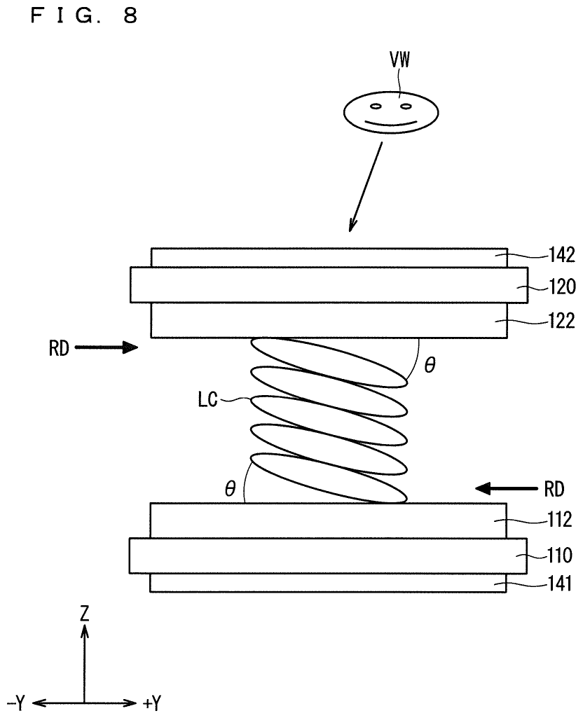

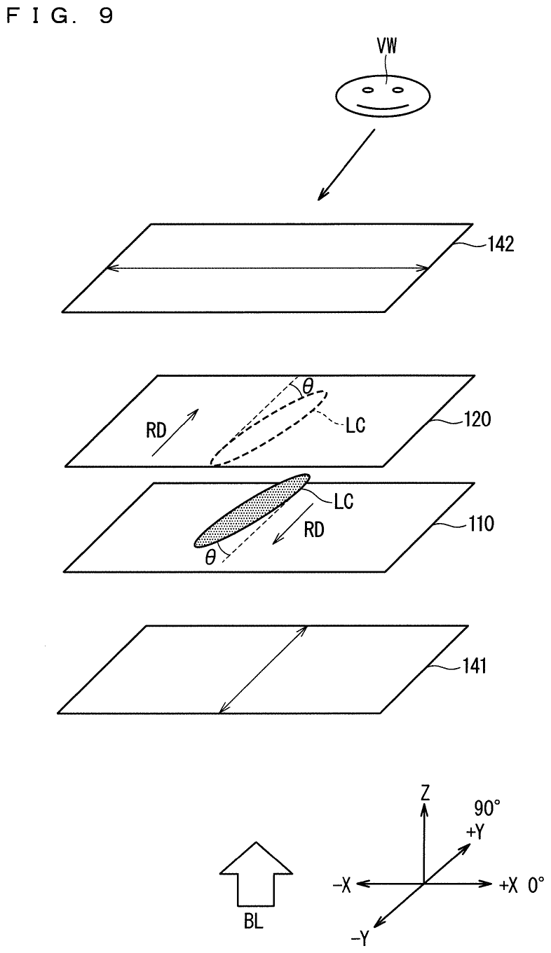

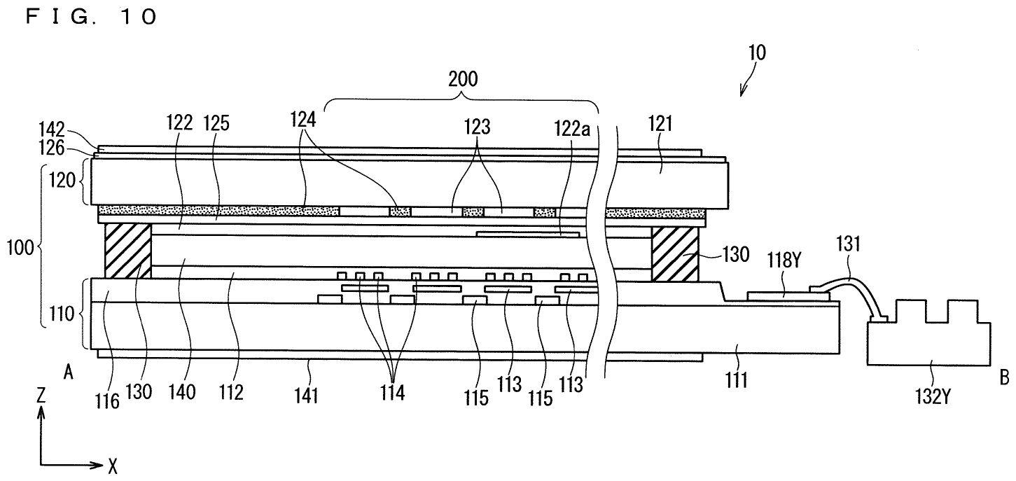

Hereinafter, a configuration capable of adjusting the viewing angle direction will be described in detail with reference to FIGS. 8 and 9. In FIGS. 8 and 9, the direction of the optimal viewing angle as viewed from the observer VW is indicated by an arrow, and the direction which is slightly higher with respect to the display area 200 of the liquid crystal panel 100, that is, the direction that maximizes the contrast when viewed from the +Y direction side slightly in the +Z direction, that is, the optimal viewing angle direction is set. In order to obtain such viewing angle characteristics, the weak anti-parallel rubbing treatment is performed on the alignment film 122 on the counter substrate 120 and the alignment film 112 on the array substrate 110 so that the rubbing directions RD are opposite to each other as illustrated by arrows in FIGS. 8 and 9.

Also, as illustrated in FIG. 9, for the alignment film 122 on the counter substrate 120, the rubbing direction RD is set in the +Y direction opposite to the optimal viewing angle direction viewed from the observer VW, and for the alignment film 112 on the array substrate 110, the rubbing direction RD is set in the −Y direction on the same direction as the optimal viewing angle direction.

Also, as illustrated in FIGS. 8 and 9, the liquid crystal molecules LC are aligned in parallel to the rubbing direction RD in the horizontal direction (Y-axis direction), in the vertical direction (Z-axis direction), on the counter substrate 120 side, a pretilt is formed with an angle θ in a direction away from the substrate surface toward in the +Y direction, on the array substrate 110 side, a pretilt is formed at an angle θ in a direction away from the substrate surface toward in the −Y direction.

FIG. 9 illustrates the arrangement relationship of the optical axes of the polarizing plates 141 and 142. The absorption axis of the polarizing plate 142 on the counter substrate 120 side is set in the 0-degree direction, that is, a direction parallel to the X-axis direction and the absorption axis of the polarizing plate 141 on the array substrate 110 side is set in the 90-degree direction, that is, a direction parallel to the Y-axis direction. Also, for the arrangement relationship between the alignment direction of the liquid crystal molecules and the optical axes of the polarizing plates, the absorption axis of the polarizing plate 141 on the incident side of the backlight BL is parallel to the alignment direction (Y-axis direction) of the liquid crystal molecules LC and the absorption axis of the polarizing plate 142 on the display region 200 side is set in a direction perpendicular to the alignment direction of the liquid crystal molecules LC.

By introducing the optical design described above, in the liquid crystal display device 10 of Embodiment 1, the direction which is slightly higher with respect to the display area 200, that is, the direction that maximizes the contrast when viewed from the +Y direction side slightly in the +Z direction, that is, the optimal viewing angle direction is set, by utilizing the minute pretilt angle. The viewing angle optimized when viewed from a slightly upper side with respect to the display area 200 is particularly suitable for a liquid crystal display device for in-vehicle use.

<Other Effects>

In Embodiment 1 described above, although the description has been made in that, by using the alignment film obtained by performing the weak rubbing treatment and the optical alignment treatment on the material of the alignment film for photo-alignment, the minute pretilt can be formed and used for the viewing angle adjustment, the effect of suppressing the occurrence of foreign substance induced faint bright spots and faint bright spots induced from minute alignment film cissing portions, which are problematic in the general alignment film, can be obtained.

Hereinafter, as another effect of Embodiment 1, an effect of improving resistance to a faint bright spot defect induced from alignment film cissing portions will be described.

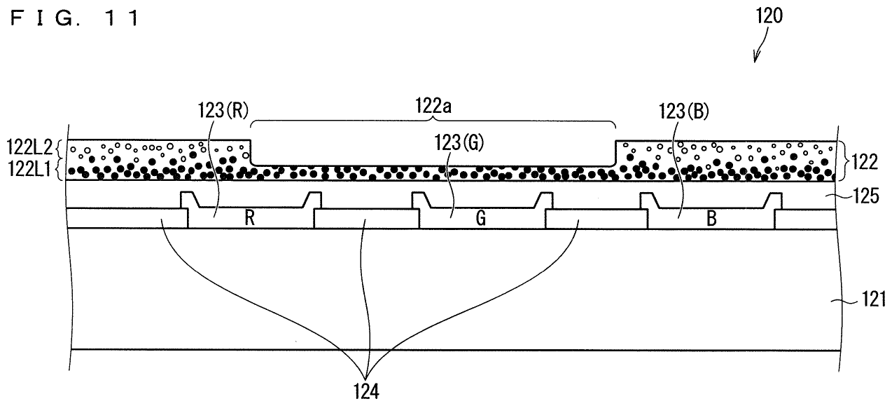

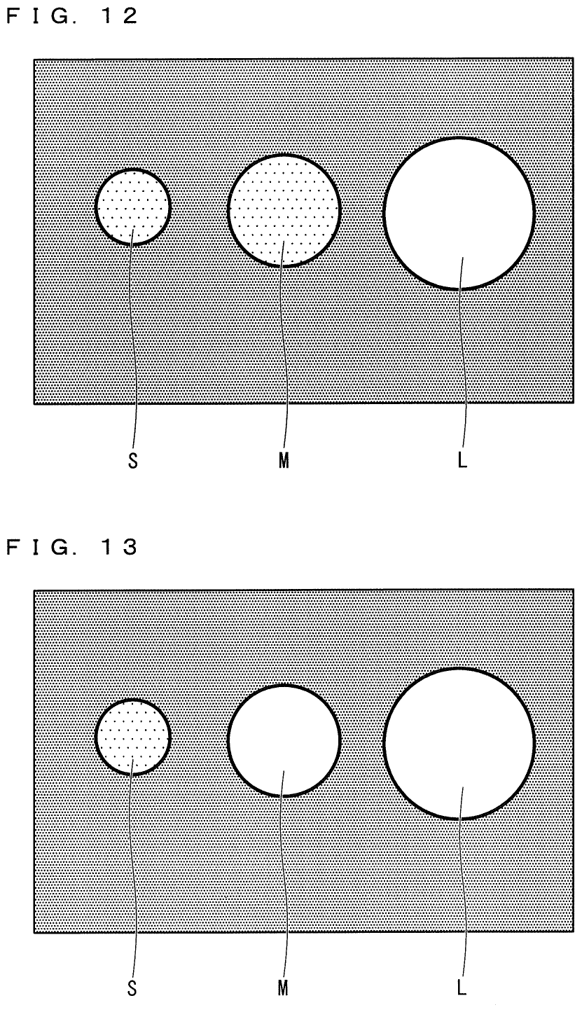

FIG. 10 is a cross-sectional view illustrating a liquid crystal display device 10a having a liquid crystal panel 100a in which an alignment film cissing portion 122a appears, and FIG. 11 is a partial sectional view to illustrate the alignment film. Note that, in FIG. 10, only the liquid crystal panel 100a is illustrated and the backlight unit, the optical sheet, the housing and the like are omitted in the drawing.

The liquid crystal panel 100a illustrated in FIG. 10 is basically the same as the liquid crystal panel 100 described with reference to FIGS. 1 and 2, the alignment films 122 and 112 are alignment films obtained by performing the weak rubbing treatment and the photo-alignment treatment on the material of the alignment film for photo-alignment.

Meanwhile, in the liquid crystal panel 100a, as illustrated in FIGS. 10 and 11, an alignment film cissing portion 122a appears in the alignment film 122. The alignment film cissing portion is a phenomenon in which a portion on which the alignment material is repelled for some reason and the alignment material is not applied is generated when the alignment material is applied onto a substrate, and is referred to a portion where the alignment film is locally disappeared. In the example illustrated in FIG. 11, the second layer 122L2 disposed above the first layer 122L1 disappears and only the first layer 122L1 remains. However, the first layer 122L1 may also disappear and the lower OC layer 125 may be exposed.

The second layer 122L2 is made of an alignment material having photo-alignment properties; therefore, an alignment state may not be formed in the region of the alignment film cissing portion 122a even if the photo-alignment treatment is performed.

However, in forming the alignment film 122, after the first layer 122L1 and the second layer 122L2 are formed, the weak rubbing treatment is performed on the surface layer of the alignment film 122; therefore, even if a region of the alignment film cissing portion 122a appears during the formation of the alignment film 122, an alignment state is formed by the rubbing treatment on the surface of the first layer 122L1 remaining in the region of the alignment film cissing portion 122a. Accordingly, the effect of suppressing occurrence of a faint bright spot defect is obtained.

Hereinafter, the effect of suppressing the occurrence of a faint bright spot defect due to the alignment film on which both the weak rubbing treatment and the photo-alignment treatment are used in combination will be described using a comparative example. FIGS. 12, 13 and 14 are schematic diagrams illustrating, when the size of the alignment film cissing portion is categorized into three levels of large (L), medium (M) and small (S), whether or not an alignment film cissing portion is visually recognized as a faint bright spot defect. Note that, as an example of the sizes of large (L), medium (M), and small (S), large (L) is about 100 μm, medium (M) is about 50 μm, and small (S) is about 10 μm, respectively. However, the ratios of the sizes of the alignment film cissing portions in the figure are not exactly represented.

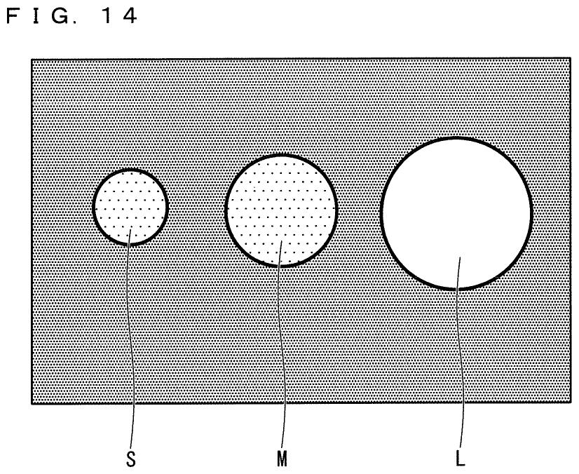

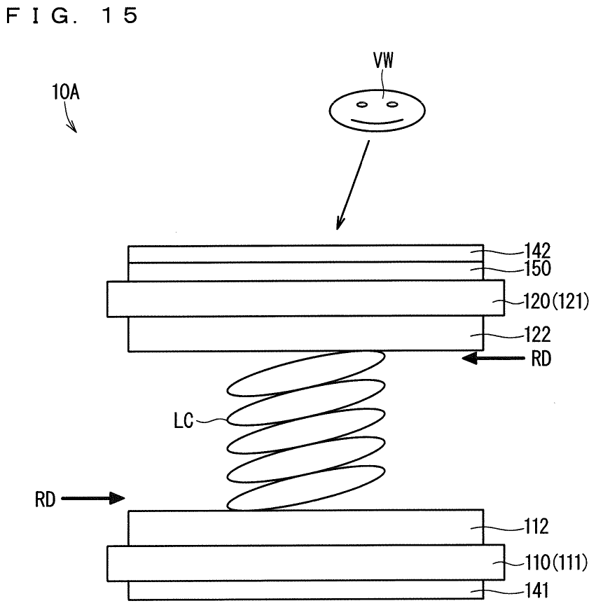

FIG. 12 illustrates an example of an alignment film in which only the rubbing treatment is performed on a general alignment film for rubbing, FIG. 13 illustrates an example of an alignment film in which only the optical-alignment treatment is performed on a general alignment film for photo-alignment, and FIG. 14 illustrates an example of an alignment film in which the weak rubbing treatment and the photo-alignment treatment are used in combination on an alignment film for photo-alignment.

As illustrated in FIG. 12, when only the rubbing treatment is performed using the alignment film for rubbing, small (S) and medium (M) sizes of the alignment film cissing portions are not visually recognized as faint bright spot defects. On the other hand, as illustrated in FIG. 13, when only the photo-alignment treatment is performed using an alignment film for photo-alignment, a small (S) size alignment film cissing portion is not visually recognized as a faint bright spot defect, however, a medium (M) size or more of the alignment film cissing portion is visually recognized as a faint bright spot defect. That is, in the case of the alignment film for photo-alignment, the resistance to the faint bright spot defect generated by the alignment film cissing portion is lower than that of the alignment film for rubbing.

Meanwhile, in the case of an alignment film in which the weak rubbing treatment and the photo-alignment treatment are used in combination, for the alignment film for photo-alignment used in Embodiment 1, as illustrated in FIG. 14, even though the alignment film for photo-alignment is used, small (S) and medium (M) sizes of alignment film cissing portions are not visibly recognized as faint bright spot defects as in the same with the case where the alignment film for rubbing is used. That is, resistance to a faint bright spot defect caused by the alignment film cissing portion is improved to about the same level as when the alignment film for rubbing is used.

This is because, as described above, the alignment state is formed by the rubbing treatment on the first layer 122L1 remaining in the region where the alignment film cissing portion 122a occurs.

In addition, regarding the improvement of the resistance to a faint bright spot defect generated by an alignment film cissing portion, even when the alignment film 122 hardly remains due to the alignment film cissing portion 122a, it can be considered that the alignment state is formed even a little by performing the rubbing treatment on the surface layer of the OC layer 125 provided below the alignment film 122.

In the above, although the case where the alignment film cissing portion 122a appears in the alignment film 122 on the counter substrate 120 has been described, for the alignment film 112 on the array substrate 110, the weak rubbing treatment and the photo-alignment treatment are used in combination on the alignment film for photo-alignment; therefore, it is needless to say that the same effect is obtained in the case where the alignment film cissing portion appears on the alignment film 122.

As described above, in the liquid crystal display device 10a, for at least one of the alignment film 122 on the counter substrate 120 and the alignment film 112 on the array substrate 110, relatively weak rubbing treatment and the photo-alignment treatment have been used in combination on the alignment film for photo-alignment. Accordingly, even in the area where alignment film cissing portion has appeared, it becomes an area with an alignment state due to the weak rubbing treatment, and as a result, resistance to faint bright spot defects caused by the alignment film cissing portion is improved.

In the above, a description has been given of a faint bright spot defect caused by the alignment film cissing portion, however, faint bright spot defects caused by minute foreign objects also occur due to the loss of parts of the photo-alignment film in the region where the minute foreign objects has appeared. For this reason, in the liquid crystal display device 10a, the effect of improving the resistance to the faint bright spot defect can be obtained as in the same with the case of the faint bright spot defect caused by the alignment film cissing portions.

Also, in the liquid crystal display device 10a, for at least one of the alignment film 122 on the counter substrate 120 and the alignment film 112 on the array substrate 110, relatively weak rubbing treatment and the photo-alignment treatment are used in combination on the alignment film for photo-alignment. Alignment scratches and alignment defects due to the rubbing treatment are unlikely to be caused. In addition, even if alignment scratches and alignment defects occur, as long as the alignment scratches or the alignment defects are minor, the alignment scratches and alignment defects are not visibly recognized as alignment defects in the display area 200 since an alignment regulation force is given by a photo-alignment treatment performed after the rubbing treatment. In other words, the effect that almost no troubles associated with the general rubbing treatment occur is also obtained.

<Modification>

Subsequently, as a modification of Embodiment 1, as a configuration for adjusting the viewing angle direction, a description will be given of pretilt angle setting and an arrangement relationship of the optical axes of each optical film in a configuration in which a retardation plate is added in addition to optical films such as polarizing plates 141 and 142 arranged on the main surface of the liquid crystal panel 100.

<Modification 1>

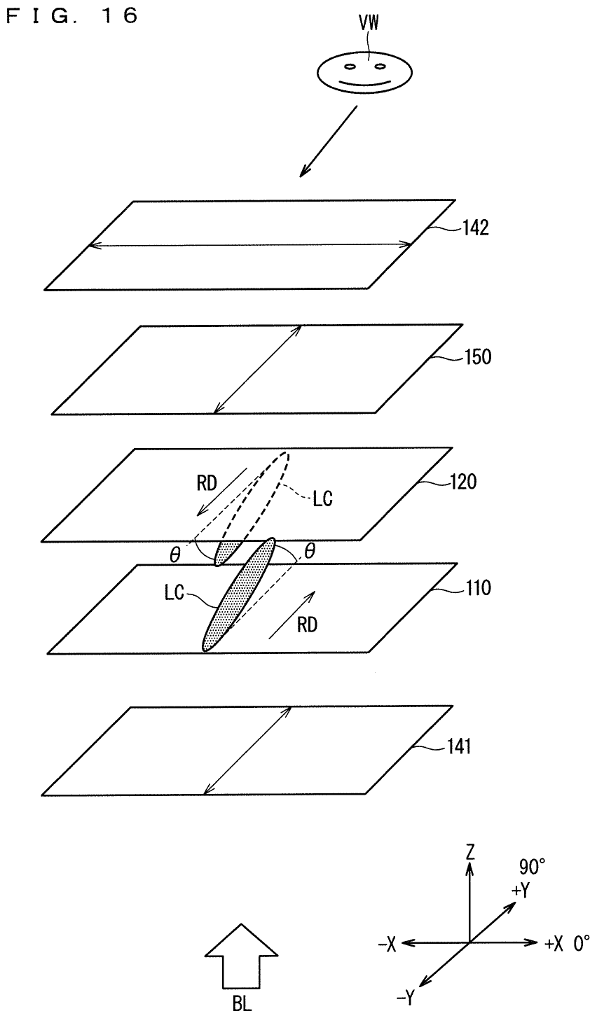

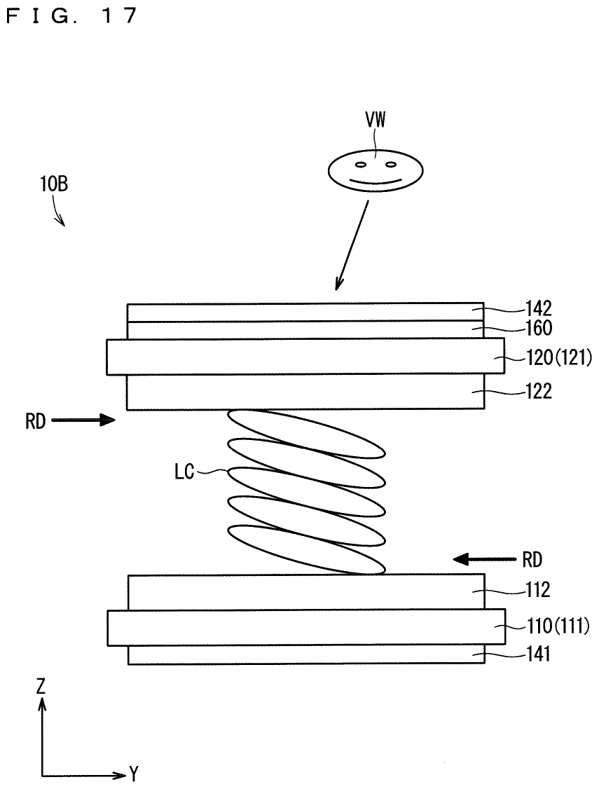

FIGS. 15 and 16 illustrate a liquid crystal display device 10A according to Modification 1 of Embodiment 1, in which a biaxial retardation plate 150 having a single-layer structure is provided between the polarizing plate 142 on the counter substrate 120 side and the glass substrate 121. The biaxial retardation plate 150 used here has, for example, a single-layer structure in which an optical compensation plate is stretched in the Z-axis direction, which is the thickness direction, and a NAZ film manufactured by NITTO DENKO CORPORATION is adoptable.

In FIG. 15, the direction of the optimal viewing angle as viewed from the observer VW is indicated by an arrow, and the direction which is slightly higher with respect to the display area 200 of the liquid crystal panel 100, that is, the direction that maximizes the contrast when viewed from the +Y direction side slightly in the +Z direction, that is, the optimal viewing angle direction is set. In Modification 1, the positional relationship of the pretilt angle described in Embodiment 1 with reference to FIGS. 8 and 9 is reversed so that such a viewing angle characteristic can be obtained.

That is, as illustrated in FIG. 15 and FIG. 16, anti-parallel weak rubbing treatment is performed on both the alignment film 122 on the counter substrate 120 and the alignment film 112 on the array substrate 110, which is common to the alignment film of Embodiment 1, however, on the alignment film 122 on the counter substrate 120, the rubbing direction RD is set in the −Y direction which is on the same side as the optimal viewing angle direction viewed from the observer VW and, on the alignment film 112 on the array substrate 110, the rubbing direction RD is set in the +Y direction opposite to the optimal viewing angle direction.

Also, as illustrated in FIGS. 15 and 16, the liquid crystal molecules LC are aligned in parallel to the rubbing direction RD in the horizontal direction (Y-axis direction),in the vertical direction (Z-axis direction), on the counter substrate 120 side, a pretilt is formed with an angle 8 in a direction away from the substrate surface toward in the −Y direction, on the array substrate 110 side, a pretilt is formed at an angle θ in a direction away from the substrate surface toward in the +Y direction.

FIG. 16 illustrates the arrangement relationship of the optical axes of the polarizing plates 141 and 142 and the biaxial retardation plate 150. The absorption axis of the polarizing plate 142 on the counter substrate 120 side is set in the 0-degree direction, that is, a direction parallel to the X-axis direction and the absorption axis of the polarizing plate 141 on the array substrate 110 side is set in the 90-degree direction, that is, a direction parallel to the Y-axis direction.

Further, the slow axis of the biaxial retardation plate 150 is set in the 90-degree direction, that is, the direction parallel to the Y-axis direction. Also, for the arrangement relationship between the alignment direction of the liquid crystal molecules and the optical axes of the polarizing plates, the absorption axis of the polarizing plate 141 on the incident side of the backlight BL is parallel to the alignment direction (Y-axis direction) of the liquid crystal molecules LC and the absorption axis of the polarizing plate 142 on the display region 200 side is set in a direction perpendicular to the alignment direction of the liquid crystal molecules LC. Further, the slow axis of the biaxial retardation plate 150 is set in a direction parallel to the alignment direction (Y-axis direction) of the liquid crystal molecules LC.

By introducing the optical design described above, also in the liquid crystal display device 10A of Modification 1, similar to the liquid crystal display device 10 of Embodiment 1, the direction which is slightly higher with respect to the display area 200, that is, the direction that maximizes the contrast when viewed from the +Y direction side slightly in the +Z direction, that is, the optimal viewing angle direction is set, by utilizing the minute pretilt angle. The viewing angle optimized when viewed from a slightly upper side with respect to the display area 200 is particularly suitable for a liquid crystal display device for in-vehicle use. Further, the addition of the biaxial retardation plate 150 further increases the contrast when viewed from an oblique direction.

<Modification 2>

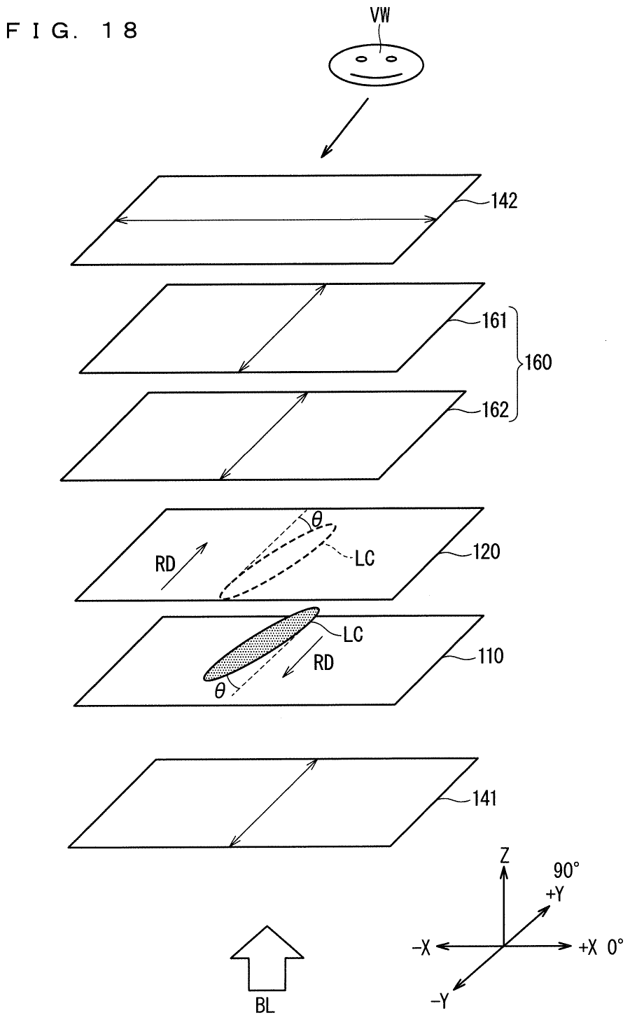

FIGS. 17 and 18 illustrate a liquid crystal display device 10A according to Modification 2 of Embodiment 1, in which a biaxial retardation plate 160 having a laminated structure is provided between the polarizing plate 142 on the counter substrate 120 side and the glass substrate 121, The biaxial retardation plate 160 used here is a laminated structure in which, for example, a retardation layer 161 (first retardation layer) having a positive refractive index anisotropy and a retardation layer 162 (second retardation layer) having a negative refractive index anisotropy are laminated in order from the display surface side. An NSPZ film, which is a uniaxially-stretched two-layer laminate type retardation film manufactured by NITTO DENKO CORPORATION, is adoptable. The NSPZ film is, for example, a known film disclosed in Japanese Patent Application Laid-Open No. 2016-191900.

In FIG. 17, the direction of the optimal viewing angle as viewed from the observer VW is indicated by an arrow, and the direction which is slightly higher with respect to the display area 200 of the liquid crystal panel 100, that is, the direction that maximizes the contrast when viewed from the +Y direction side slightly in the +Z direction, that is, the optimal viewing angle direction is set. In Modification 2, the same positional relationship with the positional relationship of the pretilt angle described in Embodiment 1 with reference to FIGS. 8 and 9 is adopted so that such a viewing angle characteristic can be obtained.

That is, as illustrated in FIG. 17 and FIG. 18, anti-parallel weak rubbing treatment is performed on both the alignment film 122 on the counter substrate 120 and the alignment film 112 on the array substrate 110, which is common to the alignment film of Embodiment 1, further, on the alignment film 122 on the counter substrate 120, the rubbing direction RD is set in the +Y direction which opposite to the optimal viewing angle direction viewed from the observer VW and, on the alignment film 112 on the array substrate 110, the rubbing direction RD is set in the −Y direction which is on the same side as the optimal viewing angle direction.

Also, as illustrated in FIGS. 17 and 18, the liquid crystal molecules LC are aligned in parallel to the rubbing direction RD in the horizontal direction (Y-axis direction), in the vertical direction (Z-axis direction), on the counter substrate 120 side, a pretilt is formed with an angle θ in a direction away from the substrate surface toward in the +Y direction, on the array substrate 110 side, a pretilt is formed at an angle θ in a direction away from the substrate surface toward in the −Y direction.

FIG. 18 illustrates the arrangement relationship of the optical axes of the polarizing plates 141 and 142 and the biaxial retardation plate 160. The absorption axis of the polarizing plate 142 on the counter substrate 120 side is set in the 0-degree direction, that is, a direction parallel to the X-axis direction and the absorption axis of the polarizing plate 141 on the array substrate 110 side is set in the 90-degree direction, that is, a direction parallel to the Y-axis direction.

Further, the slow axis of the biaxial retardation plate 160 is set in the 90-degree direction along with the retardation layer 161 and the retardation layer 162, that is, the direction parallel to the Y-axis direction. Also, for the arrangement relationship between the alignment direction of the liquid crystal molecules and the optical axes of the polarizing plates, the absorption axis of the polarizing plate 141 on the incident side of the backlight BL is parallel to the alignment direction (Y-axis direction) of the liquid crystal molecules LC and the absorption axis of the polarizing plate 142 on the display region 200 side is set in a direction perpendicular to the alignment direction of the liquid crystal molecules LC. Further, the slow axis of the biaxial retardation plate 160 is set in a direction parallel to the alignment direction (Y-axis direction) of the liquid crystal molecules LC.

By introducing the optical design described above, also in the liquid crystal display device 10B of Modification 2, similar to the liquid crystal display device 10 of Embodiment 1, the direction which is slightly higher with respect to the display area 200, that is, the direction that maximizes the contrast when viewed from the +Y direction side slightly in the +Z direction, that is, the optimal viewing angle direction is set, by utilizing the minute pretilt angle. The viewing angle optimized when viewed from a slightly upper side with respect to the display area 200 is particularly suitable for a liquid crystal display device for in-vehicle use. Further, the addition of the biaxial retardation plate 160 further increases the contrast when viewed from an oblique direction.

It should be noted that Embodiment of the present invention can be arbitrarily combined and can be appropriately modified or omitted without departing from the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device comprising:
an array substrate on which a plurality of thin film transistors are arranged;
a counter substrate arranged to face the array substrate;
a liquid crystal layer interposed between the array substrate and the counter substrate; and
a liquid crystal panel of a transverse field system in which liquid crystal is driven by an electric field generated in a direction parallel to the array substrate and the counter substrate, wherein
the liquid crystal panel includes
a first alignment film provided on the array substrate side, and
a second alignment film provided on the counter substrate side,
the first and second alignment films have photo-alignment properties, and
at least one of the first and second alignment films has a surface on which weak rubbing treatment is performed, of which pushing amount of the rubbing roller in the rubbing treatment is in the range of 0.01 to 0.30 mm.

2. The liquid crystal display device according to claim 1, wherein
the first and second alignment films are subjected to the weak rubbing treatment to have a relationship in which rubbing directions thereof are different from each other by 180 degrees.

3. The liquid crystal display device according to claim 1, wherein
the first and second alignment films are a phase-separated alignment film including a first layer on a lower layer side which is on a substrate side and a second layer on an upper layer side, and
the second layer is formed of a photo-alignment film material having photo-alignment properties.

4. The liquid crystal display device according to claim 2, further comprising:
a first polarizing plate provided outside the array substrate; and
a second polarizing plate provided outside the counter substrate, wherein
for the first alignment film, the rubbing direction is set in a same direction as an optimal viewing angle direction, which is a direction in which a contrast of a display surface of the liquid crystal panel is maximized, and
for the second alignment film, the rubbing direction is set in a direction opposite to the optimal viewing angle direction.

5. The liquid crystal display device according to claim 2, further comprising:
a first polarizing plate provided outside the array substrate;
a biaxial retardation plate provided outside the counter substrate; and
a second polarizing plate provided outside the biaxial retardation plate, wherein
the biaxial retardation plate has a single-layer structure in which an optical compensation plate is stretched in a thickness direction,
for the second alignment film, the rubbing direction is set in a same direction as an optimal viewing angle direction, which is a direction in which a contrast of a display surface of the liquid crystal panel is maximized, and
the first alignment film, the rubbing direction is set in a direction opposite to the optimal viewing angle direction.

6. The liquid crystal display device according to claim 2, further comprising:
a first polarizing plate provided outside the array substrate;
a biaxial retardation plate provided outside the counter substrate; and
a second polarizing plate provided outside the biaxial retardation plate, wherein
the biaxial retardation plate has a laminated structure in which a first retardation layer having a positive refractive index anisotropy and a second retardation layer having a negative refractive index anisotropy are laminate in order from the second polarizing plate,
for the first alignment film, the rubbing direction is set in a same direction as an optimal viewing angle direction, which is a direction in which a contrast of a display surface of the liquid crystal panel is maximized, and
for the second alignment film, the rubbing direction is set in a direction opposite to the optimal viewing angle direction.

7. The liquid crystal display device according to claim 3, wherein
the first layer has a concentration gradient such that a concentration of a first alignment agent mainly contained in the first layer is gradually reduced from the lower layer toward the upper layer, and
the second layer has a concentration gradient such that a concentration of a second alignment agent mainly contained in the second layer is gradually reduced from the upper layer toward the lower layer.

8. A method of manufacturing the liquid crystal display device according to claim 3, wherein
the weak rubbing treatment is performed after the first and second layers are formed.

9. The method of manufacturing the liquid crystal display device according to claim 8, wherein
after the weak rubbing treatment is performed on at least one of the first and second alignment films, photo-alignment treatment is performed on the second layers of the first and second alignment films.
